(19) United States
(12) Patent Application Publication
(10) Pub. No.: US 2019/0308052 A1
(43) Pub. Date: Oct. 10, 2019

(54) Interactive Science Technology Engineering Arts Mathematics (S.T.E.A.M.) Themed Centers to Provide a Unique Combination of Entertainment, Exercise and Education

(71) Applicant: Gregory Samuel Mendolia, Lithia, FL (US)

(72) Inventor: Gregory Samuel Mendolia, Lithia, FL (US)

(21) Appl. No.: 16/293,943

(22) Filed: Mar. 6, 2019

Related U.S. Application Data
(60) Provisional application No. 62/655,288, filed on Apr. 10, 2018.

(51) Int. Cl. A63B 21/005; A63B 71/06; G09B 23/00; G09B 27/00; G06T 19/00

(52) U.S. Cl. CPC A63B 21/0055; A63B 71/0622; G06T 19/003; G09B 27/00; G09B 23/00

(57) ABSTRACT

The present invention proposes the creation of a new class of business which offers an alternative for parents who wish to efficiently provide their children with simultaneous immersion in a S.T.E.A.M. (Science Technology Engineering Arts Math) themed environment while engaging in interactive, captivating play and extensive exercise. This patent proposes the creation of centers enabled by the use of exercise stations(s) powered by children to create interactive motion of objects with a S.T.E.A.M. theme, allowing an efficient and simultaneous means to educate, exercise and entertain children. In the preferred embodiment, these exercise stations are powered by children to raise various illuminated balls, which in turn will travel down various clear tubes or open tracks, creating the appearance of moving stellar objects such as comets, shooting stars and/or planets. This is a new class of business where ALL exhibits will combine exercise, S.T.E.A.M. education and entertainment. The business offers parents a very attractive alternative to current children centers and can be monetized in numerous ways.

The key feature of this patent is the use of children-powered exercise stations which convert children's kinetic energy into a variety of electrical, electromechanical or mechanical motion which in turn drive S.T.E.A.M. themed elements such as the lifting of galactic-looking balls which then travel down various clear tubes or open tracks, creating the appearance of moving stellar objects such as comets, shooting stars and/or planets. The exercise stations can alternatively drive any S.T.E.A.M. themed device such as Van Der Graph machines, Jacob's Ladders or Tesla coils.

These exercise stations enable children to simultaneously exercise, enjoy healthy entertainment, and experience deep immersion in S.T.E.A.M., inspiring them to become further involved in science and technology. The centers create a unique offering which provides a very time-efficient and cost-effective alternative for children to exercise, have fun, and most importantly gain a lasting passion for S.T.E.A.M. One fundamental goal of this patent is to simply give children “the gift of awe” with respect to S.T.E.A.M. A second fundamental goal is to provide healthy exercise simultaneously with the first goal.

### BACKGROUND OF THE INVENTION

Today's children face mounting global challenges in competitive careers within Science, Technology, Engineering, Arts, and Mathematics (S.T.E.A.M.). Gaining a strong passion for S.T.E.A.M. at a young age is critical to the success of our next generation. Additionally, less than 8% of women graduate with S.T.E.A.M. degrees, and American children of both genders are falling dangerously behind their international counterparts. Parents currently have very little options when it comes to motivating children to pursue S.T.E.A.M. education in a manner that is fun and convenient.

This invention proposes the creation of centers where parents can bring children to efficiently and simultaneously provide them with exercise, entertainment and instill a passion for S.T.E.A.M. education in a fun and immersive manner. These centers will provide parents a very cost-effective alternative to current offerings which do not combine all three of these elements in a thoughtful and purposeful manner.

### SUMMARY OF THE INVENTION

This invention proposes the creation of a new class of business combining education, exercise and entertainment, and is enabled by the creation of center(s) where children are immersed in a S.T.E.A.M. (Science Technology Engineering Arts Math) themed environment while engaging in interactive play and extensive exercise. These centers are enabled by the use of exercise station(s) powered by children to create interactive motion of objects with a S.T.E.A.M. theme. In the preferred embodiment, these exercise stations are powered by children to raise various balls, which in turn will travel down clear tubes or open tracks, creating the appearance of moving stellar objects such as comets, shooting stars and/or planets. Alternatively, these exercise stations can be designed to use energy generated by children to power other S.T.E.A.M. themed elements such as high voltage Van Der Graph machines, Archimedes' screws, lasers, high voltage Jacob's Ladders or high voltage Tesla coils generating “lightning”.

This novel and efficient new business method combining exercise, S.T.E.A.M education and entertainment can be monetized in a number of ways, such as offering annual or monthly memberships at a fixed fee per member, or charging a simple per-use fee as customers enter the centers, and eventually offering franchises to operate such centers throughout the USA and other countries.

### BRIEF DESCRIPTION OF THE DRAWINGS

For a more complete understanding of the present invention, reference is made to the following detailed description taken in conjunction with the accompanying drawings wherein:

FIG. 1 is an example of the most basic depiction of a key component of this invention; a core exercise station 100. These core exercise stations 100 convert kinetic energy from children into captivating S.T.E.A.M. themed motions such as illuminated balls 102 simulating comets, or generating electricity to power high voltage Jacob's Ladders or Tesla coils.

FIG. 2 illustrates the heart of this invention, the creation of interactive S.T.E.A.M. themed centers 200. These centers incorporate a plethora of exercise stations 100 to allow children to simultaneously exercise, gain passion for S.T.E.A.M., all while immersed in fun entertainment.

### PRIOR ART

Parents currently have many choices on where to bring their children for entertainment, education and exercise. However, NO current businesses offer a venue where ALL children activities instills in a passion for Science, Technology, Engineering, Arts, and Mathematics (S.T.E.A.M.), while simultaneously providing significant full-body exercise and immersive entertainment.

The main categories of places currently available to entertain, educate or provide exercise for children are as follows . . .
1. Science centers and children museums
2. Indoor and outdoor playgrounds
3. Educational afterschool programs
4. Video arcades

None of these four categories of places provide a one-stop combination of offerings that excites children in S.T.E.A.M., provides full upper and lower body exercise, and creates a fun captivating experience.

All science centers and children museums throughout major cities have interactive exhibits and expose children to various levels of S.T.E.A.M. However, these centers do not have exhibits in which ALL provide physical exercise to burn off energy while simultaneously gaining a passion to learn more about S.T.E.A.M. Most if not all of these centers have exhibits which are focused far more on nurturing the mind as opposed to nurturing the body. Additionally, most interactive exhibits at science centers are electronic in nature, where children press buttons or touch-screens to answer questions or trigger an event.

Local indoor and outdoor playgrounds provide significant exercise, but provide visitors little or no focus on S.T.E.A.M. Additionally, physical exercise is often heavily weighted towards use of children's lower body and do not provide much exercise of upper body and arms. In general, playgrounds are very focused on nurturing the body (at least the lower body via slides) as opposed to nurturing the mind. This is also true for places offering trampoline activities, mini-golf, go-carting, and other activities more focused on entertainment, and not focused on stimulating interest in S.T.E.A.M. education or providing a well-balanced exercise experience.

Yet another type of children's center such as Chuck-e-Cheese provides only arcade-like entertainment. These types of centers provide the least amount of mental or physical benefit and focus more on fun. Activities at these placed provide very little to nurture either the mind or the body.

### DETAILED DESCRIPTION OF THE INVENTION

Today, there are no establishments for parents to bring their children to simultaneously engage in healthy extensive exercise, and gain a passion for education focused on Science Technology Engineering Arts Mathematics (S.T.E.A.M.), all while enjoying an immersive experience which is fun and entertaining. In the preferred embodiment, an indoor playground is proposed that utilizes mainly human-powered (typically children) attractions and exhibits designed to provide significant upper and/or lower body exercise while stimulating early interest in S.T.E.A.M. The main intent of this invention is to create centers where children have so much fun that they do not even realize the tremendous benefit they are simultaneously acquiring through exercise and exposure to S.T.E.A.M., allowing parents to give their children “the gift of awe”.

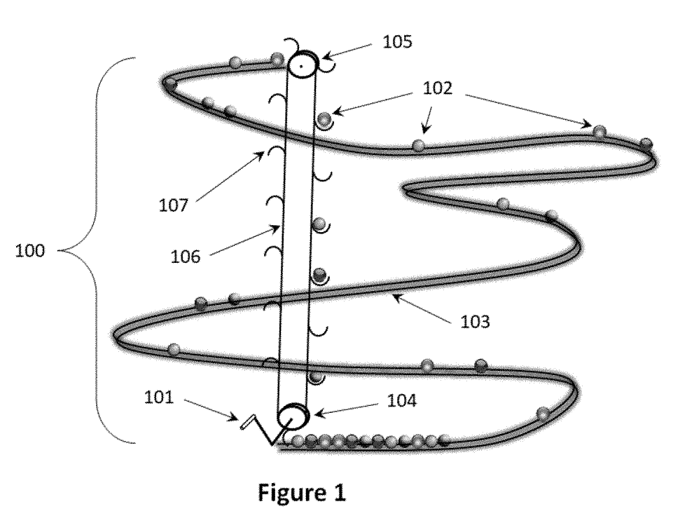

In the preferred embodiment, these S.T.E.A.M. focused centers will incorporate as their main feature, “exercise stations” 100 shown in FIG. 1. These exercise stations 100 will be designed as a mechanical device powered either by foot pedals and/or hand pedals 101. These stations 100 will utilize this mechanical motion powered by young adults (not shown), to raise various balls 102, which in turn will travel down various clear tubes or open tracks 103, creating the appearance of moving stellar objects such as comets, shooting stars and/or planets. Alternatively, ropes or levers could be used in place of pedals 101, using a “dumping” motion (not shown) to lift and dump the balls 102 to the top of the tracks 103 or clear tubes. In the preferred embodiment, these balls 102 will be illuminated either by LEDs or similarly lit devises (not shown) inside the balls, and/or balls treated with phosphorescent materials combined with UV black lighting or lasers (not shown). There would be a plethora of such balls 102, all circulating within or even between each exercise station 100, up to these various tracks and/or clear tubes 103, and finally returning back to the bottom of the exercise station 100.

In the example above describing the core station 100 in FIG. 1, there would be a bottom pully or gear 104 to which the hand or foot pedals 101 would be connected. Additionally, there would be a top pully or gear 105, a chain or similar component 106 running between the bottom pully 104 and top pully 105, with a plethora of “ball scoops” 107 connected to the chain 106. This arrangement of devices will allow the balls 102 to be elevated to the top of the exercise station 100 and set in motion down the tracks/tubes 103, all powered by children. The tracks/tubes 103 would ideally be 3m to 6m tall. The lighting of the balls 102 could also be done by human power, but in the more basic embodiment, the balls would be lit by other conventional means such as L.E.D.'s or lasers. Each exercise station 100 will typically hold 30-60 balls 102. The mechanisms used for harnessing children's physical energy can be accomplished in many alternative ways, not limited to those described here; other means include but are not limited to treadmills, rope/pully combinations, Archimedes screw, or even using the kinetic and potential energy of children as they slide, bounce or climb steps.

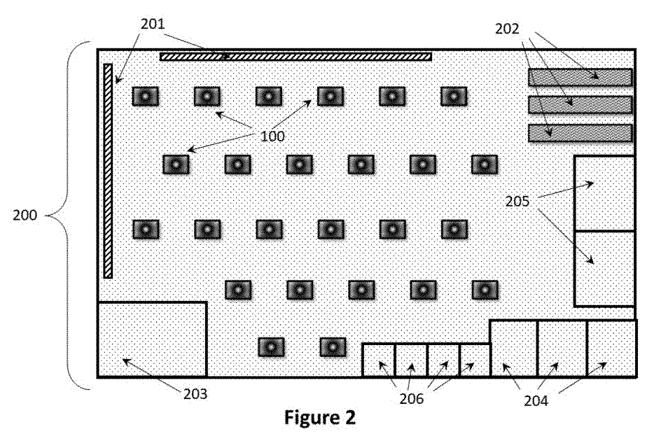

FIG. 2 is an example of one possible floorplan for the preferred embodiment of this invention, where the interactive S.T.E.A.M. themed center 200 is designed as an indoor playground to simultaneously provide fun and exercise while instilling in children a passion for S.T.E.A.M. The main feature of this invention is the creation of centers where children will be so immersed in fun and amazement that they do not even realize the tremendous benefit they are simultaneously acquiring through exercise and exposure to S.T.E.A.M., thus giving them “the gift of awe”, inspiring them to become more involved in S.T.E.A.M. education and career paths.

Multiple business models can be used to monetize this new category of S.T.E.A.M. themed centers 200. Some examples of business models include but are not limited to;
1. Offering annual or monthly memberships at a fixed fee per member based on age.
2. Simple per-use fee as customers enter the centers 200.
3. Offer franchises to open these centers 200.
4. Partner with non-competitive industry sectors such as bookstores, daycares, schools or early learning companies to jointly leverage and monetize these centers 200, even cohabitating in the same or adjacent structures.

Additionally, to augment these business models or monetization approaches, one can offer free or discounted admission programs for schools that promote this invention via special contests or when students reach an exceptional grade level. (typically in elementary schools). Further revenue streams can be created countless ways, including the solicitation of sponsors, whether they be corporate or individuals.

As can be seen from FIG. 2, the center 200 in the preferred embodiment will consist of multiple exercise stations 100 inside the center 200. Ideally, there would be 10-30 such exercise stations 100 within one such center. The exercise stations 100 can be designed to have their tracks 103 and balls 102 overlap and/or interconnect, or conversely be designed to not overlap with other stations 100. These centers 200 would preferably have tall ceilings, approximately 5-8 meters, to accommodate both short and tall exercise stations 100. For the preferred embodiment, each exercise station 100 will have a barrier between the balls 102/other moving components and the children, thus reducing the chance of injury to the children by preventing access to the balls 102 or the tracks 103 or other needed mechanisms within the stations 100.

Optionally, there can be a variety of other features in these centers 200 to build on the central theme of S.T.E.A.M. and create a more immersive experience. In the preferred embodiment, large screens 201 on the walls will display a variety of S.T.E.A.M. animated or still images such as rotating galaxies, areal videos of different natural wonders of the earth, or short educational clips. These large screens 201 can be realized using any conventional display technology such as but not limited to LED displays, projection systems, or any other display technology. To augment entertainment, various slides 202 can be included, and can be enhanced with laser, LED or any other form of lighting or sound, (inside or outside the slides) in keeping with the central theme of S.T.E.A.M. Additionally, the ceiling of the centers 200 can be decorated with various lighting such as strip LEDs, lasers, or screens showing galaxies, planets, comets and other space objects, all complimenting the S.T.E.A.M. theme.

These centers 200 can also incorporate other features often required to accommodate children and their parents. Typically, these centers 200 will include an entrance 203 housing functional areas such as but not limited to the reception area, cashier, concessions for sale of healthy food and/or novelties, and a coat/shoe room. In addition, there can be separate rooms 204 constructed to accommodate individual birthday parties. For practical purposes, there will also be various restrooms 205 for patrons of these centers 200. In addition, these centers can incorporate separate rooms 206 to show educational documentaries to some of the children, giving them an opportunity to rest between physical activities.

In the preferred embodiment of this invention, the interactive S.T.E.A.M. themed centers 200 would be built with a galaxy/space theme in mind. Various elements and features would be used to design the centers 200 for such a theme. These centers 200 can also include suspended catwalks allowing children to climb up and walk/play closer to the “cosmos”. However, themes other than outer-space can obviously be used to create S.T.E.A.M. themed centers 200. Examples include but are not limited to:
1. The human body/biotech/medicine
2. The environment/earth's ecosystem
3. Computers/software/apps creation
4. Auto industry/public transportation/high speed rail
5. Oceanic and lake themes including weather and natural forces (tornados, earthquakes, hurricanes)

6. A combination of any of the above themes

These centers 200 are designed to expose children to S.T.E.A.M. in an entertaining manner that allows them to gain a passion for the sciences while exercising. Such centers 200 will not only immerse children into S.T.E.A.M. at an early age, but also plant the seeds of passion for technology that can last a lifetime. This is critical if our children are to have a successful career in any S.T.E.A.M. based industry. Parents will be able to bring their children to these centers 200 to simultaneously provide exciting emersion into S.T.E.A.M., healthy exercise, and captivating entertainment, all in an efficient cost-effective manner. The goal is to give children “the gift of awe” with respect to S.T.E.A.M.

Utilization of the children's physical energy is not limited to harnessing power for the exercise stations 100 as described earlier in this patent, but can also be used to power a variety of alternative S.T.E.A.M. themed stations. Examples of children-powered stations or exhibits that power alternative elements include but are not limited to the powering of; (all not illustrated in the FIGS.
1. High voltage Van Der Graph machines
2. Archimedes' screws
3. Lasers
4. High voltage Jacob's Ladders
5. High voltage Tesla coils to generate “lightning”
6. Magnetic levitation devices such as model trains
7. Wireless charging and launching of mini or micro drones
8. Raising water to then create a waterfall
9. Forcing air into a “bubble chamber” creating tubes of bubbles illuminated by various colored lights
10. Powering general purpose electric generators, from which the electricity created can be used to run a plethora of standard electric devices such as light bulbs, air conditioners, room heaters

All the above examples would be powered by children's physical energy at these interactive S.T.E.A.M. themed centers 200, in keeping with the main intent of this invention. In addition, various elements described above can be combined in a serial or parallel manner to trigger more than one event. For example, the raised balls 102 described in the first example of an exercise station 100 can be used, as they roll down the track, to trigger a switch that could turn on a laser and sound effects (not shown). Alternatively, the ball 102 can be used to release the energy (separately generated by other children) from a second exercise station 100 to power elements such as a Tesla coil, to create “lightning”. Endless combinations creating such a domino effect of elements can be arranged using children's energy from one or more exercise stations 100.

In yet another embodiment of this invention, the exercise stations 100 can be augmented using virtual reality (VR), such as use of VR goggles while children are exercising/creating energy on one of the exercise stations. VR goggles can augment reality in many ways, such as to show galaxies spinning faster with increased occurrences of stellar explosions as the child pedals more quickly.

What is claimed is:

1. Commercial-grade exercise station(s) for playgrounds, powered by children's energy which in turn use this energy to create potential, kinetic or electric energy to drive various Science Technology Engineering Arts Mathematics (S.T.E.A.M.) themed visual exhibits such as but not limited to high voltage Van Der Graph machines, high voltage Jacob's Ladders or Tesla coils to generate high voltage electric arcs.

2. Children center(s) comprised primarily of exercise stations of claim 1, enabling children to simultaneously exercise, be entertained, and be fully immersed in a S.T.E.A.M. themed environment, with the intent to inspire children to pursue education and careers in the field of S.T.E.A.M., while also encouraging healthy exercise and diets.

3. A new business method enabled by the creation of children center of claim 2 providing parents an efficient way to simultaneously exercise, entertain and immerse their children in a S.T.E.A.M. themed environment, with multiple ways to monetize this business model, such as but not limited to; pay-per-use, membership fees, sponsorship, or a combination of these approaches.

4. The apparatus of claim 1 to create interactive motion of objects with a S.T.E.A.M. theme, such as the raising of various balls, which in turn will travel down various clear tubes or open tracks, creating the appearance of moving stellar objects such as comets, shooting stars and/or planets.

5. The apparatus of claim 1 or 4 designed with foot pedals or hand/arm pedals, in combination with other necessary components such as ball scoops, chains, tracks or clear tubes, to raise various balls, providing children with extensive upper and lower body exercise while harnessing their energy to create visual effects supporting a S.T.E.A.M. theme.

6. The apparatus of claim 5, alternatively using ropes or levers in place of pedals, to create a “dumping” motion to lift and dump the balls to the top of the tracks or clear tubes.

7. The apparatus of claim 1, 4, 5 or 6 with the balls illuminated either by LEDs or similarly lit devises inside the balls, and/or balls treated with phosphorescent materials combined with UV black lighting, having a plethora of such balls, all circulating within or even between each exercise stations, up to the various tracks and/or tubes, and finally returning back to the bottom of the exercise station(s).

8. The apparatus of claim 1, 4, 5, 6 or 7 to power electrical or mechanical devices such as but not limited to, magnetic levitation devices, model trains, wireless charging ports, mini or micro drones, or raising water to then create a waterfall, or powering general purpose electric generators, from which the electricity created can be used to run a plethora of standard electric devices such as light bulbs, air conditioners and room heaters.

9. The apparatus of claim 1, 4, 5, 6, 7 or 8 augmented with Virtual Reality (VR).

10. The apparatus of claim 1, 4, 5, 6, 7 or 8 used to power devices which create a theme of outer-space, cosmos, galaxies and similar astronomical elements.

11. The apparatus of claim 1, 4, 5, 6, 7 or 8 used to power devices which create alternative S.T.E.A.M. themes such as but not limited to; The human body/biotech/medicine; The environment/earth's ecosystem; Computers/software/apps/hardware; Automotive industry/public transportation/high speed rail; Oceans/lakes/natural forces (tornados, earthquakes, hurricanes); A combination of any of the above or additional themes.

12. The apparatus of claim 2 incorporating food concessions focused on healthy food in keeping with the theme of S.T.E.A.M. and exercise.

13. The apparatus of claim 2 incorporating large wall displays to create animated or still images, such as but not limited to, rotating galaxies, areal videos of different natural wonders of the earth, or short educational clips, all focused to enhance the theme of S.T.E.A.M. and create a more immersive educational experience in keeping with all aspects of claim 1.

14. The apparatus of claim 2 with the ceilings of the centers designed with various lighting, such as but not limited to, strip LEDs, lasers, or screens showing galaxies, planets, comets and other space objects, all focused on the theme of S.T.E.A.M. to enhance the educational and entertainment aspects of claim 1.

15. The apparatus of claim 2 alternatively designed as an outdoor center.

16. The apparatus of claim 2 enhanced with the use of Virtual Reality (VR) goggles or other VR equipment.

17. The apparatus of claim 3 with an integrated day-care service to allow parents to leave their children at these centers, giving parents some free time without their children, as well as providing an additional revenue stream to augment the main revenue generated by the apparatus of claim 2.

18. The apparatus of claim 3 monetized by offering franchises to operate such centers.

19. The apparatus of claim 3 operated and/or co-located in partnership with non-competitive partner(s) from industry sectors such as but not limited to; bookstores, daycares, early learning companies, health food restaurants or education institutes, with the goal of jointly leveraging and monetizing the centers described in claim 2.
